(19) United States
(12) Patent Application Publication
(10) Pub. No.: US 2019/0320583 A1
(43) Pub. Date: Oct. 24, 2019

(54) GRASS COLLECTING ASSEMBLY FOR GRASS MOWER

(71) Applicant: KUBOTA CORPORATION, Osaka (JP)

(72) Inventor: Masato ASAHARA, Hyogo (JP)

(73) Assignee: KUBOTA CORPORATION, Osaka (JP)

(21) Appl. No.: 15/960,950

(22) Filed: Apr. 24, 2018

(51) Int. Cl. A01D 43/063

(52) U.S. Cl. CPC A01D 43/0636; A01D 2101/00

(57) ABSTRACT

A grass collecting assembly for a grass mower includes a bag holder provide in a strut unit supported to a vehicle body, a grass collecting bag attached to the bag holder, and a guide cover. The grass collecting bag has a bottom wall and a circumferential wall. An upper end of the circumferential wall forms an upper opening portion. The bottom wall is switchable between a discharging posture for downwardly discharging cut grass pieces accumulated in the grass collecting bag and an accumulating posture for accumulating cut grass pieces in the grass collecting bag. The guide cover guides cut grass pieces conveyed through a duct to the upper opening portion.

### TECHNICAL FIELD

This invention relates to a grass collecting assembly for collecting cut grass pieces cut by a mower unit.

### BACKGROUND ART

U.S. Pat. No. 7,594,378 discloses a riding grass mower in which a grass collecting device for collecting cut grass pieces cut by a mower unit is mounted at a rear portion of a riding type running vehicle body. This grass collecting device includes a hanger-rod type bag holder attached to a vehicle body rear portion and two grass collecting containers hooked to this bag holder. Each grass collecting container is formed of cloth material having good air permeability and sewn into an angular bag-like body. And, along an upper end opened edge thereof, a core frame comprised of a metal rod is inserted. With this, at the upper portion of the grass collecting container, there is formed a rectangular opening portion. The opening portion of the grass collecting container is covered by a guide cover mare of resin. In operation out grass pieces conveyed through a duct are discharged into the guide cover and then accumulated in the left and right grass collecting bags. When the grass collecting bags become full, these grass collecting bags will be removed from the bag holder and then turned over to discharge the accumulated cut grass pieces. Since the full grass collecting bags have significant weights, the discharging work involving removal of the grass collecting bags from the bag holder, turning-over of these grass collecting bags to discharge the cut grass pieces therein is a work requiring significant load.

### SUMMARY OF THE INVENTION

An object of the present invention is to provide a grass collecting assembly that facilitates such discharging work of cut grass pieces accumulated in a grass collecting bag.

A grass collecting assembly for a grass mower according to the present invention comprise:

a strut unit supported to a vehicle body;

a bag holder provided in the strut unit;

a grass collecting bag having a bottom wall and a circumferential wall and attached to the bag holder, an upper end of the circumferential wall forming an upper opening portion, the bottom wall being switchable between a discharging posture for downwardly discharging cut grass pieces accumulated in the grass collecting bag and an accumulating posture for accumulating cut grass pieces in the grass collecting bag; and

a guide cover for guiding cut grass pieces conveyed through a duct to the upper opening portion.

With the above-described arrangement, when the grass collecting bag becomes full with cut grass pieces, the grass mower will run to an appropriate grass collecting place. At this place, when the bottom wall is switched to the discharging posture, the cut grass pieces accumulated in the grass collecting bag will be discharged. After this discharging of the cut grass pieces, the bottom wall will be switched to the accumulating posture. Thus, the grass mower can again accumulate cut grass pieces in the grass collecting bag while effecting a grass mowing operation. In this way, since cut grass pieces can be discharged from the grass collecting bag without dismounting this grass collecting bag from the bag holder, so that the load of cut grass discharging work can be made small. Moreover, if a waste bag is set to surround the bottom wall, cut grass pieces discharged from the grass collecting bag can be caught and accommodated in this waste bag.

According to one preferred embodiment proposed for enabling the posture switchover of the bottom wall of the grass collecting bag between the discharging posture and the accumulating posture, the bottom wall comprises a bottom frame fixed to the circumferential wall and a bottom plate attached to the bottom frame to be pivotable between a first position for providing the accumulating posture and a second position for providing the discharging posture. With this arrangement, the bottom frame can serve to enhance shape stability of the circumferential wall. Moreover, since the pivotal type bottom plate is attached to this bottom frame, by a pivotal movement of this bottom frame, the side wall will be switched into the discharging posture or the accumulating posture.

If the bottom frame is configured as a rectangular tubular body and the circumferential wall is configured as a flexible mesh-like tubular body, the grass collecting container can be made light-weighted. And, its storage shape when it is not needed can be made compact for better space saving.

### BRIEF DESCRIPTION OF THE DRAWINGS

FIG. 1 is a side view of a riding type grass mower as a whole,

FIG. 2 is a plan view of the riding type grass mower as a whole,

FIG. 3 is a side view of a grass collecting assembly,

FIG. 4 is a perspective view of the grass collecting assembly,

FIG. 5 is an exploded perspective view of a bag holder and a grass collecting bag, and

FIG. 6 is a perspective view of the grass collecting bag under its discharging posture.

### DETAILED DESCRIPTION

Next, one embodiment of a grass mower mounting a grass collecting assembly according to the present invention will be explained with reference to the accompanying drawings. In this detailed description, unless indicated otherwise, a word “front” means a front side with respect to a vehicle body front-rear direction (running direction), and a word “rear” means a rear side with respect to the vehicle body front-rear direction (running direction). Further, a left-right direction or a lateral direction means a vehicle body transverse direction (vehicle body width direction) perpendicular to the vehicle body front-rear direction. Also, a word “upper” or “lower” signifies a positional relationship in the perpendicular direction of the vehicle body (vertical direction), thus indicating a relationship respecting the ground height.

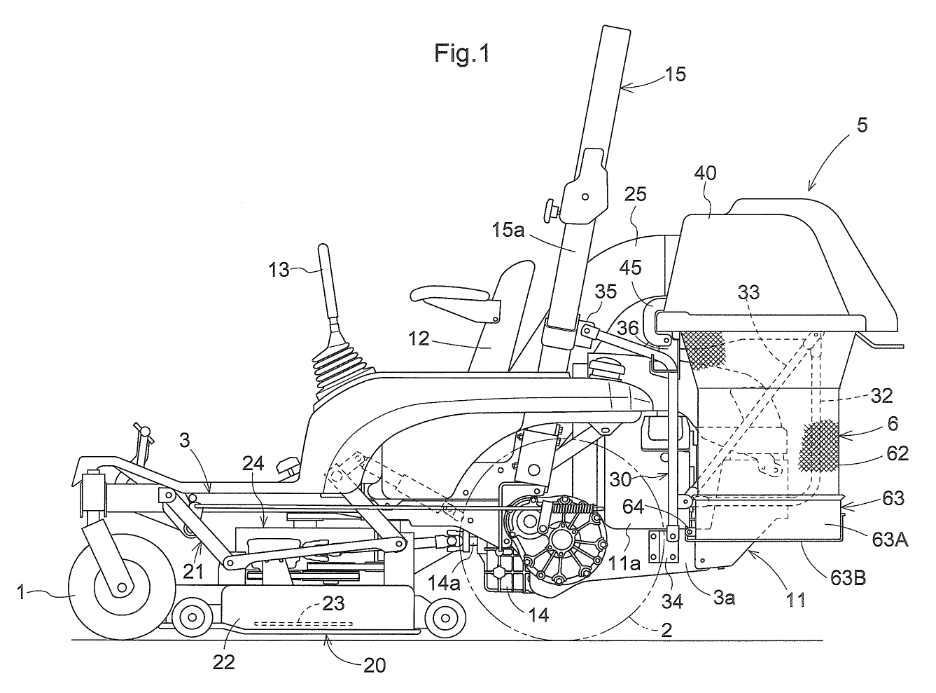

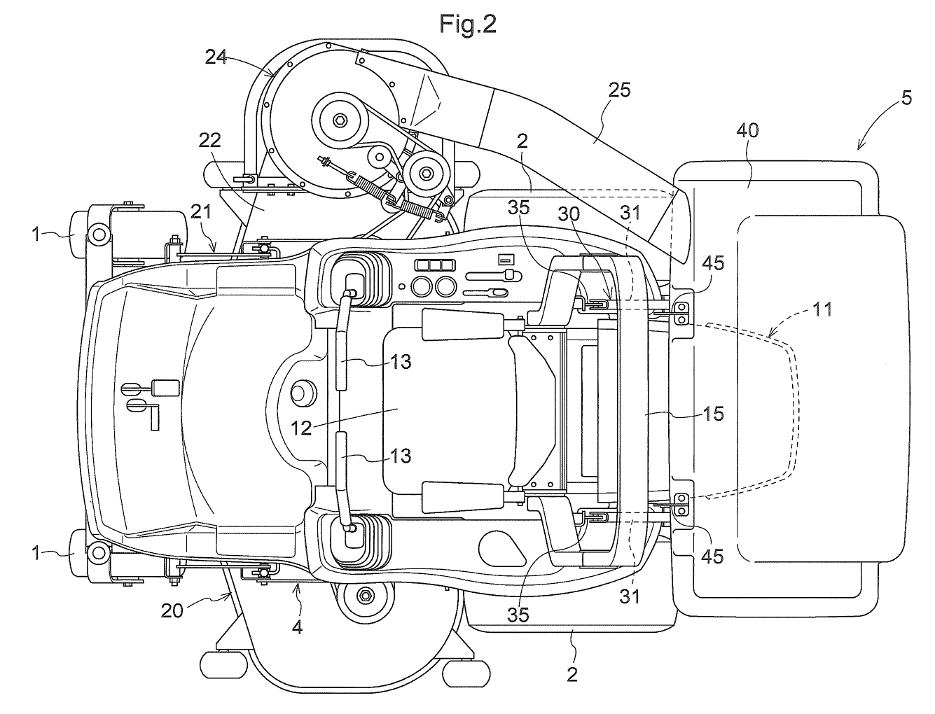

As shown in FIG. 1 and FIG. 2, this grass mower includes a pair of left and right caster type front wheels 1, a pair of driving type left and right rear wheels 2 and a vehicle body 3 supported on the ground surface by these front and rear wheels 1, 2. At a rear portion of the vehicle body 3, there is provided an engine section 11 having an engine 11a. Forwardly and upwardly of the engine section 11, a driver's seat 12 is disposed. On opposed sides of the driver's seat 12, there are disposed a pair of left and right control levers 13. Rearwardly of the driver's seat 12, a strut 15a of a ROPS 15 is disposed vertically.

Between the front wheels 1 and the rear wheels 2 and under the vehicle body 3, a mower unit 20 is suspended via a link mechanism 21. The mower unit 20 includes a mower deck 22 covering a blade 23. Power is transmitted from the engine 11a via a PTO shaft 14a of a transmission 14 to the blade 23.

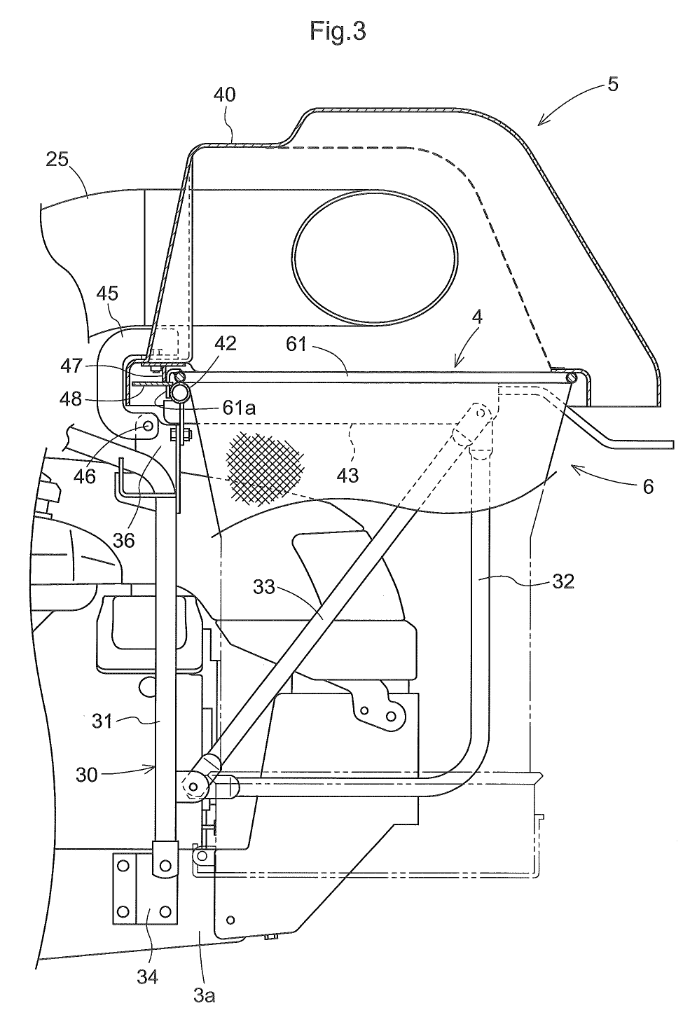

At a rear portion of the vehicle body 3, there is mounted a grass collecting assembly 5 for collecting cut grass pieces cut by the mower unit 20. This grass collecting assembly 5, as shown in FIG. 3, includes a strut unit 30 supported to the rear end of the vehicle body 3, a bag holder 4 provided in the strut unit 30, grass collecting bags 6 attached to the bag holder 4, and a guide cover 40 which covers the upper side of the grass collecting bag 6.

Conveyance of cut grass pieces from the mower unit 20 to the grass collecting assembly 5 is effected by a blower 24 provided at one lateral end portion of the mower deck 22 and a duct 25 which connects the blower 24 to the guide cover 40.

This grass mower effects a grass cutting work while running with rotating the blade 23. In response to a pivotal operation of the left operational lever 13 in the vehicle body front-rear direction, a hydrostatic stepless speed changer (not shown) for the rear wheel incorporated in the transmission 14 is speed-changed. In response to a pivotal operation of the right operational lever 13 in the vehicle body front-rear direction, a speed change ratio of the hydrostatic stepless speed changer (not shown) for the rear wheel incorporated in the transmission 14 is adjusted. With these, speeds of the left and rear wheels are adjusted independently of each other. As a result, a speed change and a steering of the grass mower can be effected as desired by a driver.

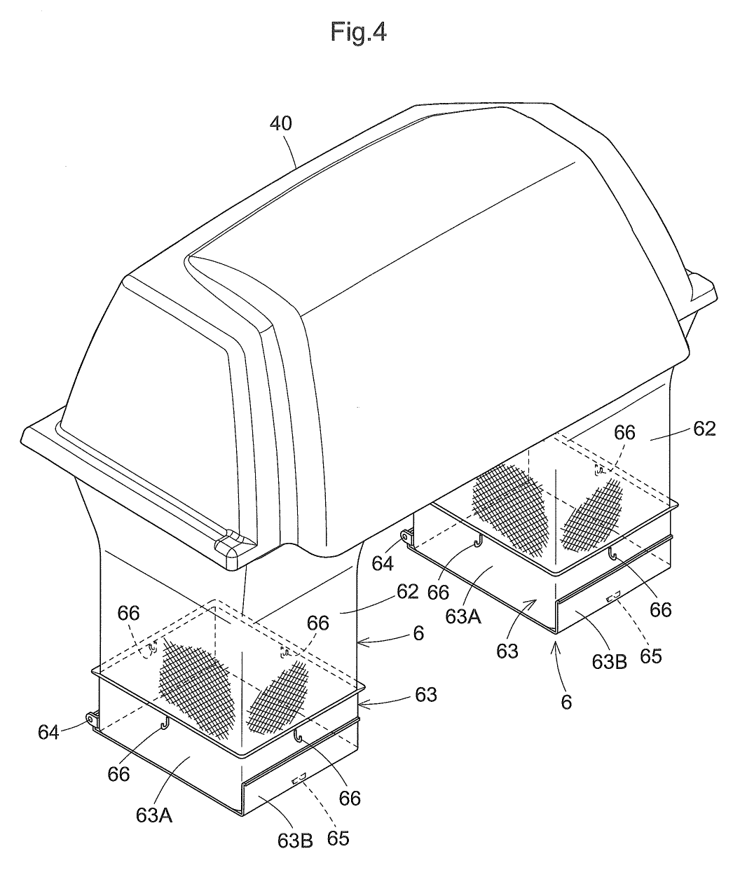

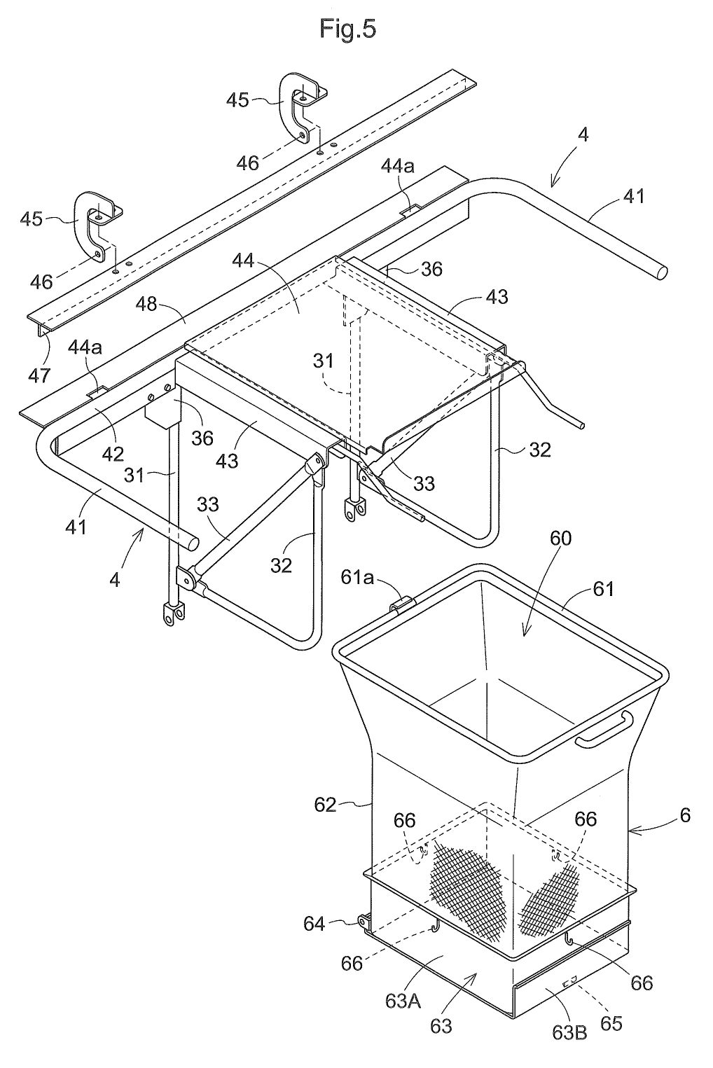

Next, with reference to FIGS. 3 through 6, the grass collecting assembly 5 will be described in details.

The bag holder 4 has a fork-like shape and consists of outer arms 41, a base rod 42 and inner arms 43. The base rod 42 extends horizontally in a vehicle body transverse direction. The outer arms 41 are around steel pipes joined to opposed ends of the base rod 42 and extending horizontally in the vehicle body front-rear direction. The inner arms 43 are downwardly oriented channel members jointed to intermediate portions of the base rod 42 and extending horizontally in the vehicle body front-rear direction. Distances between the outer arms 41 and the inner arms 43 are equal and distance between the inner arms 43 is substantially equal to a width of the engine section and a cover plate 44 is hooked thereto. A pair of left and right openings formed between the outer arms 41 and the inner arms 43 serve as insertion holes for the grass collecting bags 6.

The respective grass collecting bag 6 mounted to the pair of left and right openings of the bag holder 4 includes a circumferential wall 62 which forms a square tubular body, a rectangular annular upper end frame 61 provided at the upper end of the circumferential wall 62, and bottom wall 63 provided at the lower end of the circumferential wall 62. The upper end frame 61 creates an upper opening portion 60 of the grass collecting bag 6. The width of the upper end frame 61 is slightly larger than the pair of left and right openings formed between the outer arm 41 and the inner arm 43, so that the upper end frame 61 comes into contact with the outer arm 41 and the inner frames 43. With this, the grass collecting bag 6 is suspended from the bag holder 4. The upper end frame 61 is provided with a retainer 61a to be retained with the base rod 42 for preventing displacement of the grass collecting bag 6 when this grass collecting bag 6 is mounted to the bag holder 4.

The upper region of the circumferential wall 62 is a tubular body having an inverted square pyramid shape. As a material for forming the circumferential wall, there is employed a flexible resin material such as vinyl or cloth or a metal material such as a punching metal.

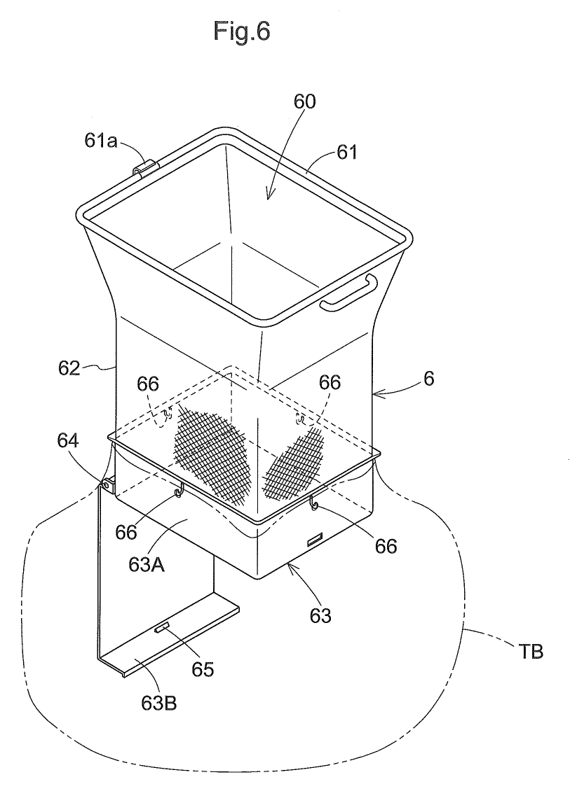

The bottom wall 63 consists of a bottom frame 63A as a square tubular body, and a bottom plate 63B pivotally attached to the bottom frame 63A via a pivot shaft 64 having a horizontal axis. The bottom plate 63B is pivotable between a first position and a second position. The bottom plate 63B, when located at the first position, closes a bottom opening defined by the bottom frame 63A, thus assuming an accumulating posture for accumulating cut grass pieces in the grass collecting bag 6. The bottom plate 63B, when located at the second position, opens up the bottom opening defined by the bottom frame 63A, thus assuming a discharging posture for downwardly discharging cut grass pieces accumulated in the grass collecting bag 6. A stopper metal tool 65 is provided for fixing the bottom plate 63B under the accumulating posture to the bottom frame 63A. Further, the bottom frame 63A, as shown in FIG. 6, is provided with a hook 66 as a holder tool for holding a trash bag TB disposed in such a manner as to surround the bottom wall 63 from under. When this trash bag TB covers the bottom wall 63 from under (when the bottom plate 63B is enclosed in the trash bag TB), if the bottom plate 63B is pivoted from the accumulating posture (first position) to the discharging posture (second position), cut grass pieces discharged from the bottom opening portion will be stored in the trash bag TB without leaking to the outside, whereby a neat and smart grass discharging operation is realized.

The strut unit 30 includes a vertical strut 31, an angle strut 32 and a brace 33. The lower end of the vertical strut 31 is connected via a bracket 34 to a rear end portion 3a of the vehicle body 3 and the upper end of the vertical strut 31 is connected via a bracket 35 to the strut 15a of the ROPS 15. The vertical strut 30 is bent at an intermediate portion thereof and this intermediate portion is connected via a bracket 36 to the base rod 42. The angle strut 32 and the brace 33 are disposed downwardly of the inner arm 43 and one end of the angle strut 32 is connected to the inner arm 43 and the other end of the angle strut 43 is connected to the vertical strut 31. The brace 33 bridges the opposed ends of the angle strut 32 so as to form a triangular structure together with this angle strut 32.

The guide cover 40 is pivotally supported to the bracket 36 via a connecting arm 45 pivotally attached via a pivot pin 46 extending in the vehicle body transverse direction and a seal plate 47. The guide cover 40 is pivotable between an opening posture upwardly detached from the bag holder 4 for allowing dismounting of the grass collecting bag 6 and a closing posture in close contact with the upper end of the bag holder 4 for covering the upper side of the upper opening portion of the grass collecting bag 6 mounted to the bag holder 4.

When the guide cover 40 assumes the closing posture, cut grass pieces conveyed through the duct 25 will be discharged into the guide cover 40. The seal plate 47 is connected to the guide cover 40 and the connecting arm 45 and comes into contact with a band plate 48 extending forwardly from the outer arm 41, when the guide cover 40 assumes the closing posture. This arrangement prevents leak of cut grass pieces through between the grass collecting bag 6 and the guide cover 40. The band plate 48 defines cutouts 44a into which the retainers 61a enter.

In the foregoing embodiment, the grass collecting bag 6 has a square tubular body having a substantially rectangular cross section.

However, the grass collecting bag 6 can have any other shape. For instance, it can have a cylindrical body shape or a polygonal tubular body shape other than a rectangular body shape. Further, it can have a cubic shape having a plurality of different cross sectional shapes. The shape of the bag holder 4 will be changed in accordance with a chosen shape of the grass collecting bag 6.

The movable bottom plate 63B constituting the bottom wall 63 can be a shutter-type instead of the pivotal type.

1. A grass collecting assembly for a grass mower comprising:
a strut unit supported to a vehicle body;
a bag holder provided in the strut unit;
a grass collecting bag having a bottom wall and a circumferential wall and attached to the bag holder, an upper end of the circumferential wall forming an upper opening portion, the bottom wall being switchable between a discharging posture for downwardly discharging cut grass pieces accumulated in the grass collecting bag and an accumulating posture for accumulating cut grass pieces in the grass collecting bag; and
a guide cover for guiding cut grass pieces conveyed through a duct to the upper opening portion.

2. The grass collecting assembly of claim 1, wherein the bottom wall comprises a bottom frame fixed to the circumferential wall and a bottom plate attached to the bottom frame to be pivotable between a first position for providing the accumulating posture and a second position for providing the discharging posture.

3. The grass collecting assembly of claim 2, wherein the bottom frame is configured as a rectangular tubular body fitted on a lower end portion of the circumferential wall and the bottom plate is vertically pivotable about a horizontal axis.

4. The grass collecting assembly of claim 1, wherein the bottom frame is provided with a holder tool for holding a trash bag disposed in such a manner as to surround the bottom frame from under; and the bottom plate is pivotable from a first position to a second position inside the held trash bag.

5. The grass collecting assembly of claim 1, wherein the grass collecting bag is detachably mounted to the bag holder.
